(19) United States
(12) Patent Application Publication
(10) Pub. No.: US 2015/0069754 A1
(43) Pub. Date: Mar. 12, 2015

(54) HOSE ATTACHING STRUCTURE

(71) Applicant: HONDA MOTOR CO., LTD., Tokyo (JP)

(72) Inventors: Kazuyoshi Miyahara, Wako-shi (JP); Kaku Okabe, Wako-shi (JP)

(73) Assignee: HONDA MOTOR CO., LTD., Tokyo (JP)

(21) Appl. No.: 14/476,899

(22) Filed: Sep. 4, 2014

(30) Foreign Application Priority Data
Sep. 6, 2013 (JP) 2013-185051

(51) Int. Cl. F16L 15/00

(52) U.S. Cl. CPC F16L 15/00
USPC 285/390

(57) ABSTRACT

An annular hose coupling is connected to a hose nipple having a hose attached thereto. The hose coupling has, on its inner peripheral surface, a non-threaded portion and a female threaded portion to be screwed onto a male threaded portion formed on a distal end portion of a suction nozzle. The non-threaded portion is located on a distal end portion of the hose coupling to be inserted over the nozzle and having such an inner diameter that the non-threaded portion is fittable over the male threaded portion of the nozzle. The hose coupling is connected to the nozzle through meshing engagement between the female threaded portion of the hose coupling and the male threaded portion of the nozzle.

### TECHNICAL FIELD

The present disclosure relates to an improvement in hose attaching structures for attaching a hose to a working apparatus.

### BACKGROUND

Among the conventionally-known hose attaching structures for attaching a hose to a working apparatus, such as a water pump, is one which is designed to attach a hose to a water pump via a hose nipple. Examples of such a hose nipple includes one that is attached to a water pump using a claw, and one that is attached to a water pump through screw or threaded coupling engagement. One example of such a hose attaching structure is disclosed in Japanese Patent Application Laid-open Publication No. HEI-2-199295 (hereinafter referred to as “the relevant patent literature”).

In the hose attaching structure disclosed in the relevant patent literature, a hose is attached to a suction opening section formed in a horizontal direction of the water pump. The suction opening section of the water pump has a female threaded (i.e., internally-threaded) portion, and a hose nipple having the hose attached thereto has a male thread (i.e., externally-threaded) portion formed on one end portion thereof. The male threaded portion of the hose nipple is screwed into the female threaded portion of the suction opening of the water pump.

However, when the hose nipple, having the hose attached thereto, is to be screwed into the suction opening of the water pump, the hose nipple would tilt due to the weight of the hose, and thus it would be difficult to bring the male and female thread portions into appropriate meshing engagement with each other. Therefore, some improvement has to be made in order to threadedly couple the hose nipple, having the hose attached thereto, to the suction opening section of the water pump.

### SUMMARY

In view of the foregoing problems, it is preferable to provide an improved technique for readily threadedly couple a hose nipple, having a hose attached hereto, to a working apparatus without being adversely influenced by the weight of the hose.

In order to accomplish the above, one aspect of the present disclosure provides an improved hose attaching structure for attaching a hose to a working apparatus, which comprises: a hose nipple having the hose attached thereto; and an annular hose coupling connected to the hose nipple, the hose coupling having, on the inner peripheral surface thereof, a non-threaded portion and a female threaded portion to be screwed onto a male threaded portion formed on a distal end portion of a nozzle of the working apparatus, the non-threaded portion being located on a distal end portion of the inner peripheral surface of the hose coupling to be inserted over the nozzle and having such an inner diameter that the non-threaded portion is fittable over the male threaded portion of the nozzle. The hose nipple connected with the hose coupling is threadedly coupled to the nozzle through meshing engagement between the female threaded portion of the hose coupling and the male threaded portion of the nozzle.

Because the non-threaded portion is formed on a distal end portion of the inner peripheral surface of the hose coupling to be inserted over the nozzle and has such an inner diameter that the non-threaded portion is fittable over the male threaded portion of the nozzle, the non-threaded portion functions as a guide for appropriately positioning the hose coupling relative to the nozzle. Namely, the non-threaded portion guides the hose coupling in such a manner that the respective axes of the hose coupling and the nozzle are brought into alignment. Thus, the present disclosure can greatly facilitate positioning of the hose coupling relative to the nozzle, preventing mutual clinging or biting between the male and female threaded portions and thus permits appropriate meshing engagement and tightening between the male and female threaded portions without being influenced by the weight of the hose. As a result, the present disclosure can readily threadedly couple the hose nipple, coupled with the hose coupling and having the hose attached thereto, to the nozzle of the working apparatus.

In an embodiment, the non-threaded portion is located closer than the female threaded portion to the distal end of the hose coupling, and the inner diameter of the non-threaded portion is substantially equal to the outer diameter of the male threaded portion of the nozzle so that, when the female threaded portion and the male threaded portion are in meshing engagement with each other, the male threaded portion is covered with the non-threaded portion. Because the non-threaded portion of the hose coupling covers the male threaded portion of the nozzle, the male threaded portion and the female threaded portion can be protected from muddy water and dirt and dust that would otherwise enter through a proximal end portion of the male threaded portion.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a sectional view of a working apparatus employing an embodiment of a hose attaching structure of the present invention;

FIG. 2 is a view showing in enlarged scape principal sections of the working apparatus shown in FIG. 1;

FIG. 3 is a view explanatory of behavior of a conventionally-known example of a hose attaching structure; and

FIG. 4 is a view explanatory of the embodiment of the hose attaching structure shown in FIG. 1.

### DETAILED DESCRIPTION

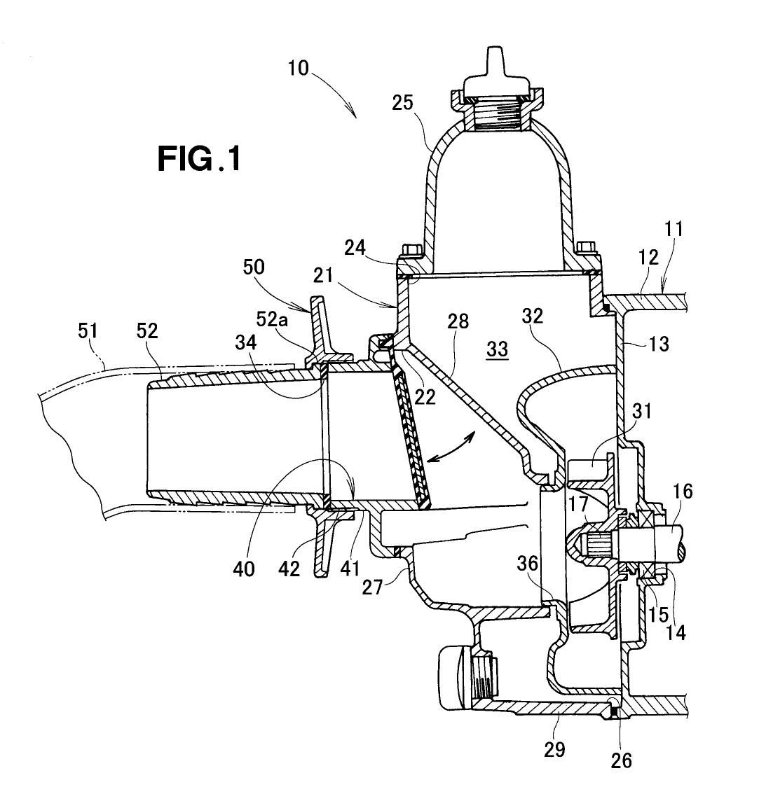

FIG. 1 is a sectional view of a working apparatus 10 which employs an embodiment of a hose attaching structure of the present invention. The working apparatus 10 is, for example, a water pump. This water pump 10 includes: an engine 11; a case 21 provided on a cylinder block 12 of the engine 11; a suction nozzle 40 provided in a suction opening section 22 of the case 21; and a discharge nozzle 25 provided in a discharge opening section 24 of the case 21.

The engine 11 includes: a partition wall 13 of the cylinder block 12; a mechanical seal 15 provided in a support hole 14 of the partition wall 13; and a crankshaft 16 rotatably mounted on the mechanical seal 15. The crankshaft 16 has an end portion 17 projecting into the case 21, and a vane wheel 31 is connected to the end portion 17 of the crankshaft 16.

A volute 32 is disposed within the case 21, and the vane wheel 31 is covered with the volute 32. The case 21 has an opening portion 26 closed with the partition wall 13 and the volute 32 is provided on the partition wall 13, so that an in-case flow passage 33 is defined with the partition wall 13, the case 21 and the volute 32. The in-case flow passage 33 is formed in a substantially annular shape between the case 21 and the volute 32.

The case 21 includes: a suction-side wall section 27 opposed to the partition wall 13; a suction passage section 28 communicating with the suction opening section 22 formed in the suction-side wall section 27; and an annular peripheral wall section 29 formed along the edge of the suction-side wall section 27.

The suction nozzle 40 extends in a horizontal direction from the suction opening section 22 and has a male threaded portion 42 formed on its distal end portion.

Further, a hose nipple 52 having a hose 51 attached thereto is connectable to the suction nozzle 40 via a hose coupling 50 in a manner to be described in detail below. A seal member 34 is disposed on the distal end of the suction nozzle 40 in such a manner that it is sandwiched between the hose nipple 52 and the suction nozzle 40 when the hose nipple 52 is connected to the hose nipple 40 via the hose coupling 50.

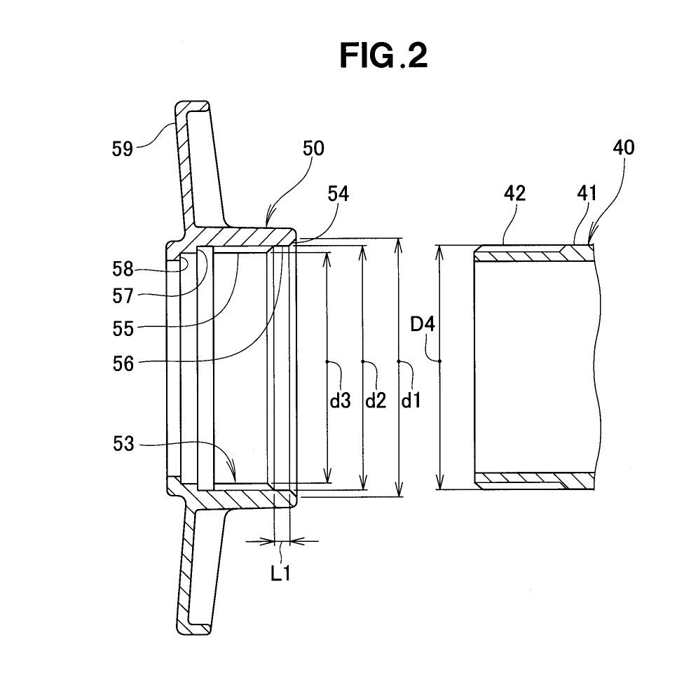

The following describe principal sections of the embodiment. As shown in FIGS. 1 and 2, the hose coupling 50 has on its inner peripheral surface 53: a taper portion 54 formed on a distal end portion of the inner peripheral surface 53; a non-threaded portion 56 to be inserted onto the male threaded portion 42 of the suction nozzle 40; a female threaded portion 55 to be screwed onto the male threaded portion 42; a seal support portion 57 supporting the seal member 34; and a flange support portion 58 supporting a flange 52a of the hose nipple 52.

Further, the hose coupling 50 has a handle section 59 such that the hose coupling 50 can be readily rotated by use of the handle section 59.

The non-threaded portion 56 of the hose coupling 50 is located closer than the female threaded portion 55 to the distal end of the hose coupling 50 to be inserted over the suction nozzle 40. Further, the taper portion 54 is located closer than the non-threaded portion 56 to the distal end of the hose coupling 50 to be inserted over the suction nozzle 40.

The taper portion 54 is formed continuously with the non-threaded portion 56 in such a manner that it becomes gradually wider (i.e., greater in inner diameter) from one end of the non-threaded portion 56 toward the distal end of the hose coupling 50. In FIG. 2, the taper portion 54 has a maximum inner diameter d1, the non-threaded portion 56 has an inner diameter d2 and the female threaded portion 56 has an inner diameter d3, and relationship among the inner diameters d1, d2 and d3 is d3<d2<d1. The trough diameter of the female threaded portion 55 is substantially equal to the inner diameter of the non-threaded portion 56.

Further, in FIG. 2, the male threaded portion 42 of the suction nozzle 40 has an outer diameter D4, and the non-threaded portion 56 has an inner diameter d2 is substantially equal to or slightly greater than the outer diameter D4 of the male threaded portion 42. Namely, the inner diameter d2 of the non-threaded portion 56 is set or chosen such that the non-threaded portion 56 is fittable over the male threaded portion 42. Further, the non-threaded portion 56 has an axial length L1 that is set to correspond to an axial distance between two adjoining threads or more of the male threaded portion 42.

Thus, when the hose coupling 50 is to be connected to the nozzle 40, first, the taper portion 54 functions as a first guide for aligning the center of the distal end portion of the nozzle 40 and the center of the distal end portion of the hose coupling 50. Then, the non-threaded portion 56 functions as a second guide for aligning the axis of the nozzle 40 and the axis of the hose coupling 50. In this way, the female threaded portion 55 of the hose coupling 50 can be tightened over the male threaded portion 42 of the nozzle 40 easily and accurately.

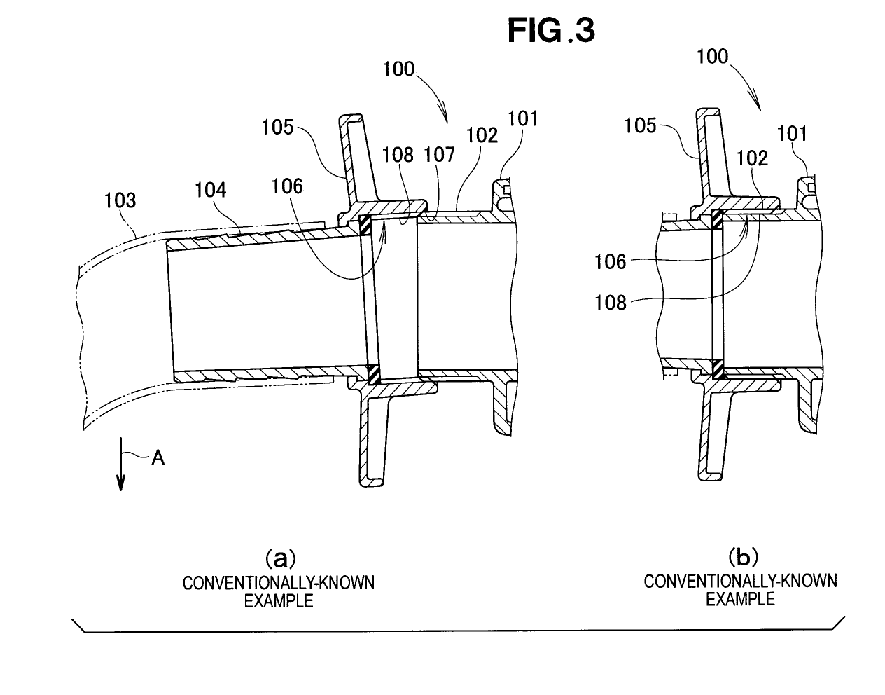

The following describe behavior of a conventionally-known example of a hose attaching structure. (a) of FIG. 3 shows a working apparatus 100 employing the conventionally-known hose attaching structure, which includes a nozzle 101 having a male threaded portion 102 formed on a distal end portion thereof. Further, an annular hose coupling 105 is connected to a hose nipple 104 having a hose 103 attached thereto. The hose coupling 105 has a taper portion 107 formed on a distal end portion of the inner peripheral surface 106 of the hose coupling 105, and a female threaded portion 108 formed continuously with the taper portion 107.

The hose nipple 104 and the hose coupling 105 are subjected to force in a direction of arrow A due to the weight of the hose 103, so that they are slightly tilted relative to the nozzle 101. When the hose coupling 105 is to be inserted over the nozzle 101, the center of the distal end portion of the nozzle 101 and the center of the distal end portion of the hose coupling 105 are aligned with each other by the guide function of the taper portion 107, but the hose nipple 104 and the hose coupling 105 stay tilted relative to the nozzle 101. Thus, the female threaded portion 108 would undesirably cling to, or bite into, the male threaded portion 102, so that the female threaded portion 108 and the male threaded portion 102 cannot be brought into appropriate meshing easily.

(b) of FIG. 3 shows a state of the working apparatus 100 after the female threaded portion 108 and the male threaded portion 102 have been brought into meshing engagement with each other. In this state, the hose coupling 105 has been inserted deep onto the nozzle 40. Because the female threaded portion 108 is formed from the distal end of the inner peripheral surface 106 of the hose coupling 105, muddy water and dirt and dust may easily enter through a proximal end portion of the male threaded portion 102.

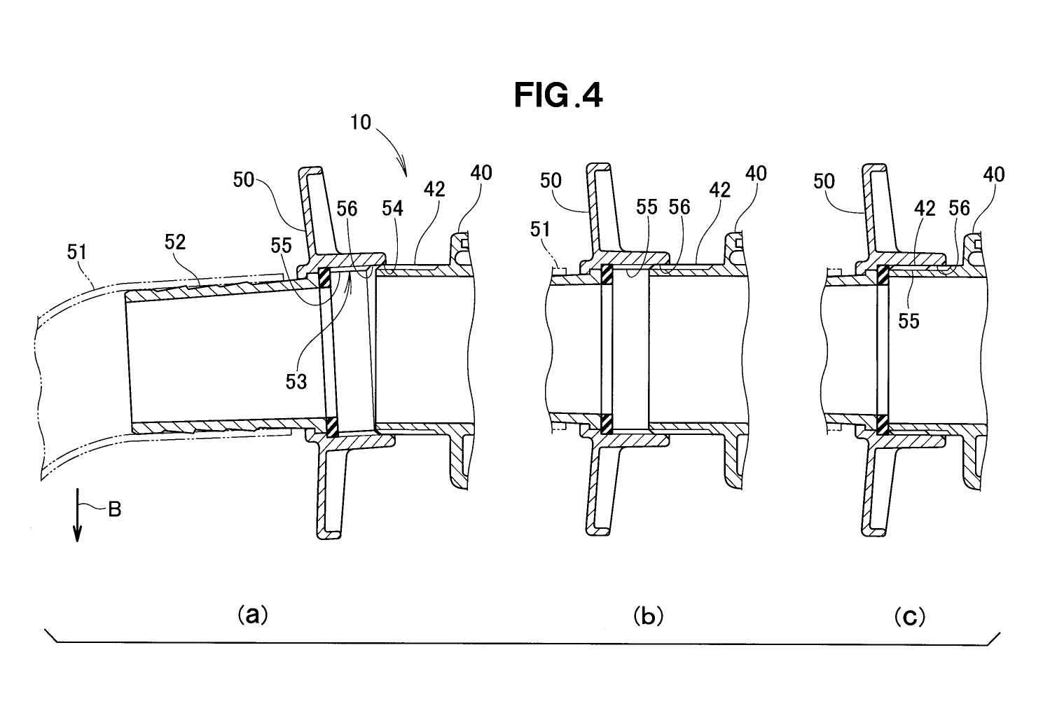

Next, a description will be given about behavior of the embodiment of the hose attaching structure. (a) of FIG. 4 shows the working apparatus 10 employing the embodiment of the hose attaching structure. The hose nipple 52 and the hose coupling 50 are subjected to force in a direction of arrow B due to the weight of the hose 51, so that they are slightly tilted relative to the nozzle 40. When the hose coupling 50 is to be inserted over the nozzle 40, the center of the distal end portion of the nozzle 40 and the center of the distal end portion of the hose coupling 50 are aligned with each other by the guide function of the taper portion 54.

(b) of FIG. 4 shows a state of the embodiment where the hose coupling 50 has been inserted slightly over the nozzle 40, from which time the non-threaded portion 56 is advanced along the male threaded portion 42 of the nozzle 40. Thus, the axes of the nozzle 40 and the hose coupling 50 are guided into alignment. This arrangement can prevent the female threaded portion 55 from clinging to, or biting into, the male threaded portion 42, so that the male threaded portion 42 and the female threaded portion 55 can be brought into appropriate meshing engagement with ease.

(c) of FIG. 4 shows a state of the working apparatus 10 after the female threaded portion 55 and the male threaded portion 42 have been brought into meshing engagement. In this state, the hose coupling 50 has been inserted deep onto the nozzle 40. Because the non-threaded portion 56 having the inner diameter substantially equal to the outer diameter of the male threaded portion 42 of the nozzle 40, the male threaded portion 42 is covered with the non-threaded portion 56, so that muddy water and dirt and dust can be prevented from entering through a proximal end portion of the male threaded portion 42 and consequently the male threaded portion 42 and the female threaded portion 55 can be protected from muddy water and dirt and dust.

The following summarizes the above-described embodiment of the hose attaching structure. As shown in FIGS. 1, 2 and 4, the non-threaded portion 56 is located in a distal end portion of the inner peripheral surface of the hose coupling 50 to be inserted over the nozzle 40, and the inner diameter d2 of the non-threaded portion 56 is set or chosen such that the non-threaded portion 56 is fittable over the male threaded portion 42. Thus, the non-threaded portion 56 of the hose coupling 50 functions as a guide for the hose coupling 50. Because the hose coupling 50 is guided by the non-threaded portion 56 in such a manner that the axes of the hose coupling 50 and the nozzle 40 are aligned with each other, positioning of the hose coupling 50 and the nozzle 40 can be greatly facilitated and unwanted biting between the male and female threaded portions 42 and 55 can be prevented reliably. Thus, the male and female threaded portions 42 and 55 can be brought into appropriate meshing engagement without being adversely influenced by the weight of the hose 51. As a result, the hose nipple 52 connected with the hose coupling 51 and having the hose 51 attached thereto can be readily screwed onto, or threadedly coupled to, the nozzle 40 of the working apparatus 10.

Further, because the non-threaded portion 56 of the hose coupling 51 covers an end portion of the male threaded portion 42 of the nozzle 40, the male and female threaded portions 42 and 55 can be protected from muddy water and dirt and dust.

Whereas the working apparatus to which is applied the embodiment of the hose attaching structure has been described above as a water pump, the working apparatus may be any other type of apparatus as long as the hose attaching structure has an annular hose coupling that is threadedly coupled to, or screwed onto, a nozzle of the working apparatus. Furthermore, whereas the embodiment of the hose attaching structure has been described above as applied to a suction nozzle, the present invention is not so limited, and it may be applied to a discharge nozzle. Further, whereas the embodiment of the hose attaching structure has been described above as applied to a nozzle extending in a horizontal direction, the present invention is not so limited, and it may be applied to a tilted nozzle or a nozzle extending in a vertical direction.

The hose attaching structure of the present disclosure is particularly well suited for attaching a hose to a nozzle of a water pump.

What is claimed is:

1. A hose attaching structure for attaching a hose to a working apparatus, the hose attaching structure comprising:
a hose nipple having the hose attached thereto; and
an annular hose coupling connected to the hose nipple, the hose coupling having, on an inner peripheral surface thereof, a non-threaded portion and a female threaded portion to be screwed onto a male threaded portion formed on a distal end portion of a nozzle of the working apparatus,
the non-threaded portion being located on a distal end portion of the inner peripheral surface of the hose coupling to be inserted over the nozzle and having such an inner diameter that the non-threaded portion is fittable over the male threaded portion of the nozzle,
the hose nipple connected with the hose coupling being threadedly coupled to the nozzle through meshing engagement between the female threaded portion of the hose coupling and the male threaded portion of the nozzle.

2. The hose attaching structure according to claim 1, wherein the non-threaded portion is located closer than the female threaded portion to a distal end of the hose coupling, and the inner diameter of the non-threaded portion is substantially equal to an outer diameter of the male threaded portion of the nozzle so that, when the female threaded portion and the male threaded portion are in meshing engagement with each other, the male threaded portion is covered with the non-threaded portion.
